(19) United States
(12) Patent Application Publication
(10) Pub. No.: US 2023/0064137 A1
(43) Pub. Date: Mar. 2, 2023

(54) SPEECH RECOGNITION APPARATUS, ACOUSTIC MODEL LEARNING APPARATUS, SPEECH RECOGNITION METHOD, AND COMPUTER-READABLE RECORDING MEDIUM

(71) Applicant: NEC Corporation, Minato-ku, Tokyo (JP)

(72) Inventors: Shuji KOMEIJI, Tokyo (JP); Yasuo IIMURA, Tokyo (JP); Hitoshi YAMAMOTO, Tokyo (JP)

(73) Assignee: NEC Corporation, Minato-ku, Tokyo (JP)

(21) Appl. No.: 17/796,340

(22) PCT Filed: Feb. 17, 2020
(86) PCT No.: PCT/JP2020/006080

§ 371 Date: Jul. 29, 2022

(51) Int. Cl. G10L 15/06; G10L 15/22; G10L 15/24

(52) U.S. Cl. CPC G10L 15/063; G10L 15/22; G10L 15/24; G10L 15/16

(57) ABSTRACT

A speech recognition apparatus 20, includes; a data acquisition unit 21 that acquires speech data and sensor data to be recognized; a speech recognition unit 22 that converts the acquired speech data into text data by applying the acquired speech data and the acquired sensor data to an acoustic model which is constructed by machine learning using an embedded vector generated from sensor data related to training data in addition to speech data to be the training data and teacher data to be the training data.

### TECHNICAL FIELD

The present invention relates to a speech recognition apparatus, an acoustic model learning apparatus, and a speech recognition method for performing speech recognition, and further relates to a computer-readable recording medium in which a program for executing these apparatus and method is recorded.

### BACKGROUND ART

Conventionally, in speech recognition, a speech signal input from a microphone is first converted into a feature value vector, and then the feature value vector is converted into a phoneme sequence by an acoustic model. After that, the phoneme string is converted into a word string by the language model, and the obtained word string is output as a recognition result. That is, in the conventional speech recognition, the signal processing by the acoustic model and the recognition processing by the language model are performed separately.

On the other hand, in speech recognition in recent years, with the progress of deep learning, a method (E2E: End to End) for integrally learning a model representing the relationship between the speech signal and the word string has been proposed. According to the E2E method, learning with a large amount of training data can be efficiently performed, so that improvement in speech recognition accuracy can be expected.

Further, in order to further improve the speech recognition accuracy, a technique using an embedded vector as a parameter of a model in E2E has been proposed (see, for example, Non-Patent Document 1). Specifically, in the technique disclosed in Non-Patent Document 1, an audio signal and a word vector related thereto are learned together to construct a model. Further, in the technique disclosed in Non-Patent Document 1, the word vector is generated, by first recognizing the speech before and after the speech to be learned, dividing the text obtained by the speech recognition into words, and by calculating an embedded vector from each word. The embedded vector may be calculated from the one-hot expression of each word.

### LIST OF RELATED ART DOCUMENTS

### Non-Patent Document

Non-Patent Document 1: Suyoun Kim, Siddharth Dalmia, and Florian Metze, “Gated Embeddings in End-to-End Speech Recognition for Conversational-Context Fusion”, [online], July 28-Aug. 2, 2019, Electrical & Computer Engineering Language Technologies Institute, School of Computer Science Carnegie Mellon University, [Search on Dec. 1, 2019], Internet<URL: https://www.aclweb.org/anthology/P19-1107.pdf>

### SUMMARY OF INVENTION

### Problems to be Solved by the Invention

According to the technique disclosed in Non-Patent Document 1 described above, it is considered that it is possible to improve the speech recognition accuracy as compared with the case where the embedded vector is not used. However, in the technique disclosed in Non-Patent Document 1 described above, since the embedded vector itself is generated by speech recognition, there is a limit to improving the speech recognition accuracy.

An example object is to solve the above problem, and to provide a speech recognition apparatus, a speech recognition method, and a computer-readable recording medium that perform a speech recognition using an embedded vector generated without using speech recognition. And also, the example object is to provide an acoustic model learning apparatus that learns an acoustic model for performing the speech recognition.

### Means for Solving the Problems

In order to achieve the above-described object, a speech recognition apparatus according to an example aspect of the invention includes:

a data acquisition unit that acquires speech data and sensor data to be recognized,

a speech recognition unit that converts the acquired speech data into text data by applying the acquired speech data and the acquired sensor data to an acoustic model which is constructed by machine learning using an embedded vector generated from sensor data related to training data in addition to speech data to be the training data and teacher data to be the training data.

In order to achieve the above-described object, an acoustic model learning apparatus according to an example aspect of the invention includes:

a data acquisition unit that acquires speech data to be training data, teacher data to be the training data, and sensor data related to the training data,

an acoustic model construction unit constructs an acoustic model by machine learning using embedded vector generated from the sensor data related to the training data in addition to the speech data to be the training data and the teacher data to be the training data.

In addition, in order to achieve the above-described object, a speech recognition method according to an example aspect of the invention includes:

a data acquisition step of acquiring speech data and sensor data to be recognized,

a speech recognition step of converting the acquired speech data into text data by applying the acquired speech data and the acquired sensor data to an acoustic model which is constructed by machine learning using an embedded vector generated from sensor data related to training data in addition to speech data to be the training data and teacher data to be the training data.

Further, in order to achieve the above-described object, a computer-readable recording medium according to an example aspect of the invention that includes a program recorded thereon, the program including instructions that cause a computer to carry out:

a data acquisition step of acquiring speech data and sensor data to be recognized,

a speech recognition step of converting the acquired speech data into text data by applying the acquired speech data and the acquired sensor data to an acoustic model which is constructed by machine learning using an embedded vector generated from sensor data related to training data in addition to speech data to be the training data and teacher data to be the training data.

### Advantageous Effects of the Invention

As described above, according to the present invention, it is possible to perform the speech recognition using the embedded vector generated without using speech recognition.

### BRIEF DESCRIPTION OF THE DRAWINGS

FIG. 1 is a block diagram illustrating a configuration of an acoustic model learning apparatus according to a first example embodiment.

FIG. 2 illustrates a first example of an embedded vector generated from image data.

FIG. 3 illustrates an example of an embedded vector generated from temperature data.

FIG. 4 illustrates an example of an embedded vector generated from location data.

FIG. 5 illustrates an example of an embedded vector generated from time data.

FIG. 6 illustrates an example of an embedded vector generated from a convolutional neural network.

FIG. 7 is a flow diagram illustrating an operation of the acoustic model learning apparatus according to the first example embodiment.

FIG. 8 is a block diagram illustrating a configuration of a speech recognition apparatus according to a second example embodiment.

FIG. 9 is a flow diagram illustrating an operation of the speech recognition apparatus according to the second example embodiment.

FIG. 10 is a block diagram illustrating a configuration of a speech recognition apparatus according to a modified example of the second example embodiment.

FIG. 11 is a block diagram illustrating an example of a computer that realizes the acoustic model learning apparatus or the speech recognition apparatus according to the example embodiments.

### EXAMPLE EMBODIMENT

### First Example Embodiment

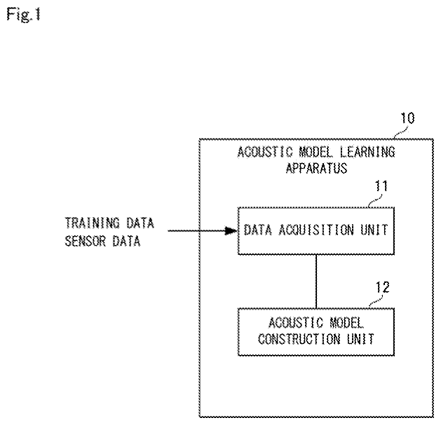

Hereinafter, in the first example embodiment, an acoustic model learning apparatus, an acoustic model learning method, and a program for realizing these will be described with reference to FIGS. 1 to 7.

[Apparatus Configuration]

First, a configuration of the acoustic model learning apparatus according to the first example embodiment will be described using FIG. 1. FIG. 1 is the block diagram illustrating the configuration of the acoustic model learning apparatus according to the first example embodiment.

The acoustic model learning apparatus 10 according to the first example embodiment shown in FIG. 1 is an apparatus for generating an acoustic model. As shown in FIG. 1, the acoustic model learning apparatus 10 includes a data acquisition unit 11 and an acoustic model construction unit 12.

In this configuration, the data acquisition unit 11 acquires speech data to be training data, teacher data to be the training data, and sensor data related to the training data. The acoustic model construction unit 12 constructs an acoustic model by machine learning using embedded vector in addition to the speech data to be training data and teacher data to be the training data. The embedded vector is generated from the sensor data related to the acquired training data by the data acquisition unit 11.

As described above, in the first example embodiment, the acoustic model learning apparatus 10 can construct the acoustic model using the embedded vector generated without using speech recognition.

Subsequently, the configuration and function of the acoustic model learning apparatus 10 according to the first example embodiment will be described more specifically.

First, in the first example embodiment, the data acquisition unit 11 acquires speech data and teacher data to be training data from an external terminal device or the like connected by a network or the like. The teacher data is text data obtained by transcribing the utterance of the speech data.

In the first example embodiment, the acoustic model construction unit 12 first generates an embedded vector using the sensor data related to the training data. Specifically, when the sensor data is input, the acoustic model construction unit 12 inputs the sensor data related to the training data into the model that outputs the data related to the sensor data, and generates the embedded vector from the data output from the model. Examples of the sensor data include image data, temperature data, location data, time data, illuminance data, and the like. In the first example embodiment, any one of these is used.

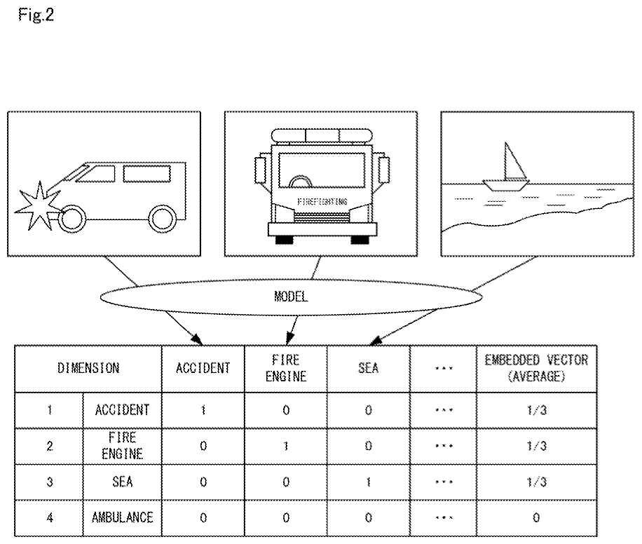

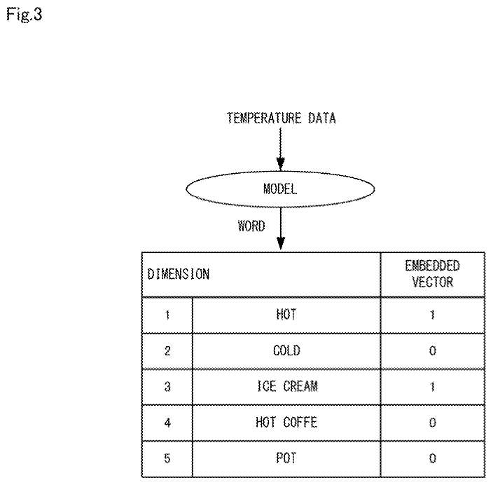

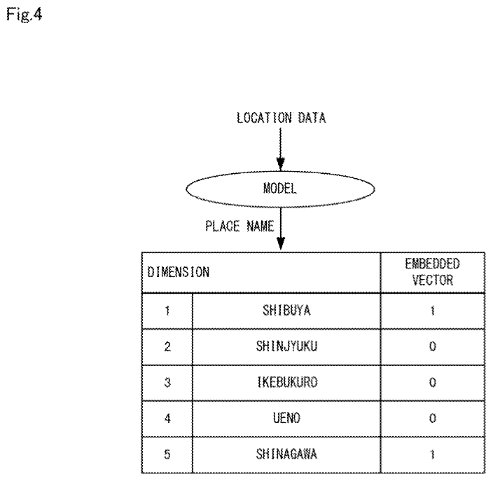

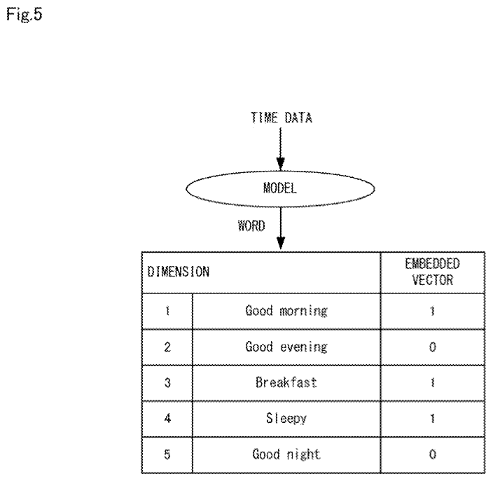

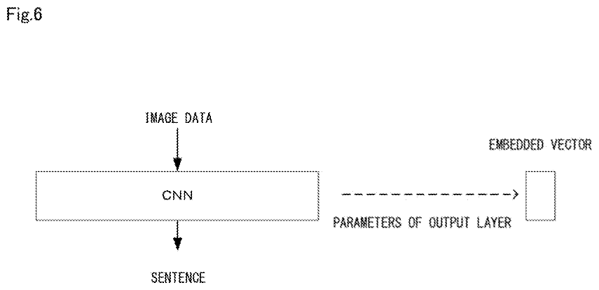

An example of the embedded vector will be described below with reference to FIGS. 2 to 6. FIG. 2 illustrates a first example of an embedded vector generated from image data. FIG. 3 illustrates an example of an embedded vector generated from temperature data. FIG. 4 illustrates an example of an embedded vector generated from location data. FIG. 5 illustrates an example of an embedded vector generated from time data. FIG. 6 illustrates an example of an embedded vector generated from a convolutional neural network.

In the example of FIG. 2, when the image data is input, the acoustic model construction unit 12 first performs image recognition by inputting the image data to the model that outputs the text data explaining the image data, and acquires a text related to the image data. Next, the acoustic model construction unit 12 applies the acquired text data to each dimension (leftmost column) of the preset vector, and generates one-hot vector as the embedded vector.

For example, in FIG. 2, when the image of the image data is recognized as “accident”, the embedded vector is (1,0,0,0). Similarly, the embedded vector is (0,1,0,0), when it is recognized as “fire engine”. The embedded vector is (0,0,1,0), when it is recognized as “sea”. Further, as the embedded vector, the average value, the addition value, or the maximum value of the vectors obtained from each recognition result may be used. FIG. 2 also shows an example (⅓, ⅓, ⅓, 0) in which the average value is used as the embedded vector.

In the example of FIG. 3, first, when the temperature data is input, the acoustic model construction unit 12 inputs the temperature data to the model that outputs the word related to the temperature data, causes the model to output the word corresponding to the temperature data, and then acquires the output word. Next, the acoustic model construction unit 12 applies the acquired word to each dimension (leftmost column) of the preset vector to generate the embedded vector by setting the dimension matched the word to “1”, the dimension did not match the word to “0”.

In the example of FIG. 4, first, when the location data is input, the acoustic model construction unit 12 inputs the location data to the model that outputs the related to (or close to) the location data, causes the model to output the place name corresponding to the location data, and then acquires the output place name. Next, the acoustic model construction unit 12 applies the acquired place name to each dimension (leftmost column) of the preset vector to generate the embedded vector by setting the dimension matched the place name to “1”, the dimension did not match the place name to “0”. In the example of FIG. 4, the vector value may be continuous value proportional to the distance instead of “0” and “1”.

In the example of FIG. 5, first, when the time data is input, the acoustic model construction unit 12 first inputs the time data to the model that outputs the word related to the time data, causes the model to output the word corresponding to the time data, and then acquires the output word.

Next, the acoustic model construction unit 12 applies the acquired word to each dimension (leftmost column) of the preset vector to generate the embedded vector by setting the dimension matched the word to “1”, the dimension did not match the word to “0”.

In the example of FIG. 6, when the image data is input, the acoustic model construction unit 12 acquires parameters of an output layer (hidden layer) of a convolutional neural network (CNN). The CNN is trained to output a sentence related to the image data. Then, the acoustic model construction unit 12 obtains the average value, the addition value, or the maximum value of the acquired parameters, and uses the obtained values as the embedded vector. Further, the acoustic model construction unit 12 can also use the state of the parameter of the output layer of the CNN as the embedded vector.

Further, in the example of FIG. 6, the CNN is trained so that the output layer when the image data is input to the CNN and the output layer when the sentence representing the content of the image data is input to the CNN are close to each other. For example, if the image data showing a car accident is input to CNN, the CNN is trained so that the output layer when the image data is input is closer to the output device when the sentence “The car has an accident” is input to CNN.

[Apparatus Operation]

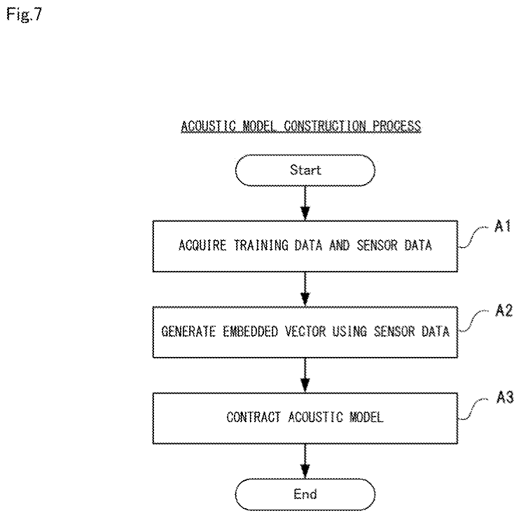

Next, the operation of the acoustic model learning apparatus 10 according to the first example embodiment will be described with reference to FIG. 7. FIG. 7 is a flow diagram illustrating an operation of the acoustic model learning apparatus according to the first example embodiment. In the following description, FIGS. 1 to 6 will be referred to as appropriate. Further, in the first example embodiment, the acoustic model learning method is implemented by operating the acoustic model learning apparatus 10. Therefore, the following description of the operation of the acoustic model learning apparatus 10 applies to the acoustic model learning method according to the first example embodiment.

As shown in FIG. 7, first, the data acquisition unit 11 acquires speech data and teacher data as training data, and sensor data related to the training data (step A1). Further, as the data acquisition destination in step A1, an external terminal device or the like connected by a network, or the like can be mentioned.

Next, the acoustic model construction unit 12 generates an embedded vector using the sensor data acquired in step A1 (step A2). Specifically, for example, when the sensor data is image data, the acoustic model construction unit 12 generates the embedded vector by the method shown in FIG. 2 or FIG. 6. Further, when the sensor data is temperature data, the acoustic model construction unit 12 generates the embedded vector by the method shown in FIG. 3. When the sensor data is location data, the acoustic model construction unit 12 generates the embedded vector by the method shown in FIG. 4.

Next, the acoustic model construction unit 12 contracts the acoustic model by adding the embedded vector generated in step A2 to the training data acquired in step A1 and executing machine learning (step A3). Specifically, the acoustic model construction unit 12 updates the parameters of the acoustic model by inputting the training data and the embedded vector into the existing acoustic model, for example.

Steps A1 to A3 are executed each time training data is acquired. Further, by repeatedly executing steps A1 to A3, the accuracy of the acoustic model is also improved.

As described above, according to the first example embodiment, it is possible to construct the acoustic model using the embedded vector generated without using speech recognition. Therefore, according to this acoustic model, it is possible to perform speech recognition using an embedded vector generated without using speech recognition.

[Modified example]

In the first example embodiment described above, the sensor data is only one of the image data, the temperature data, the location data, the time data, and the illuminance data, but the first example embodiment is not limited to this aspect. In the first example embodiment, the sensor data may be a combination of two or more among image data, temperature data, location data, time data, and illuminance data. Further, in this case, the acoustic model construction unit 12 generates the embedded vector for each of the combined sensor data and executes machine learning using the generated embedded vector for each combined sensor data.

[Program]

It is sufficient that the program according to the first example embodiment be a program that causes a computer to execute steps A1 to A3 illustrated in FIG. 7. The acoustic model learning apparatus 10 and the acoustic model learning method according to the first example embodiment can be realized by installing this program in the computer and executing this program. In this case, a processor of the computer functions and performs processing as the data acquisition unit 11 and the acoustic model construction unit 12. Further, example of the computer includes a general-purpose PC, and also a smartphone and tablet-type terminal device.

Also, the program according to the first example embodiment may be executed by a computer system constructed by a plurality of computers. In this case, for example, each computer may function as one of the data acquisition unit 11 and the acoustic model construction unit 12.

### Second Example Embodiment

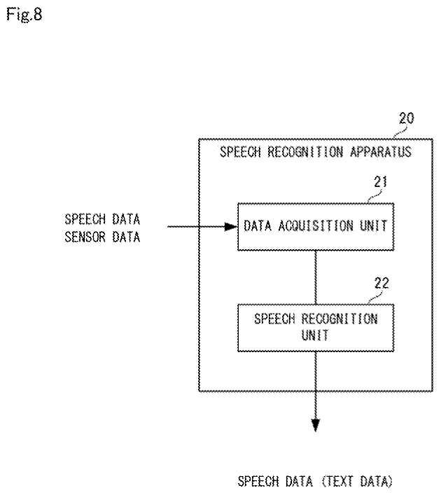

Next, in the second example embodiment, a speech recognition apparatus, a speech recognition method, and a program for realizing these will be described with reference to FIGS. 8 to 10.

[Apparatus Configuration]

First, a configuration of the speech recognition apparatus according to the second example embodiment will be described with reference to FIG. 8. FIG. 8 is a block diagram illustrating a configuration of a speech recognition apparatus according to a second example embodiment.

The speech recognition apparatus 20 according to the second example embodiment shown in FIG. 8 is an apparatus that performs speech recognition using an acoustic model. As shown in FIG. 8, the speech recognition apparatus 20 includes a data acquisition unit 21 and a speech recognition unit 22.

In this configuration, the data acquisition unit 21 acquires speech data and sensor data to be recognized. The speech recognition unit 22 converts the acquired speech data into text data by applying the acquired speech data and sensor data to the acoustic model.

Further, in the second example embodiment, the acoustic model is constructed by machine learning using an embedded vector generated from sensor data related to the training data in addition to the speech data to be the training data and teacher data to be the training data.

Therefore, according to the speech recognition apparatus 20 in the second example embodiment, the speech recognition can be executed by using the embedded vector generated without using the speech recognition.

Subsequently, the configuration and function of the speech recognition apparatus 20 according to the second example embodiment will be described more specifically.

First, in the second example embodiment, the data acquisition unit 21 acquires speech data and sensor data to be recognized from an external terminal device or the like connected by a network or the like. Examples of the sensor data include image data, temperature data, location data, time data, illuminance data, and the like, as in the first example embodiment.

Further, the acoustic model used in the second example embodiment is constructed by the acoustic model learning apparatus 10 according to the first example embodiment using the embedded vector. Therefore, in the second example embodiment, the speech recognition unit 22 first generates the embedded vector from the sensor data acquired by the data acquisition unit 21. Specifically, the speech recognition unit 22 generates the embedded vector by the same method as the acoustic model construction unit 12 according to the first example embodiment.

For example, when the sensor data is image data, the speech recognition unit 22 generates the embedded vector by the method shown in FIG. 2 or FIG. 6. Further, when the sensor data is temperature data, the speech recognition unit 12 generates the embedded vector by the method shown in FIG. 3. When the sensor data is location data, the speech recognition unit 12 generates the embedded vector by the method shown in FIG. 4. When the sensor data is time data, the speech recognition unit 12 generates the embedded vector by the method shown in FIG. 5.

Then, the speech recognition unit 22 converts the speech data into text data by applying the speech data and the generated embedded vector to the acoustic model.

[Apparatus Operation]

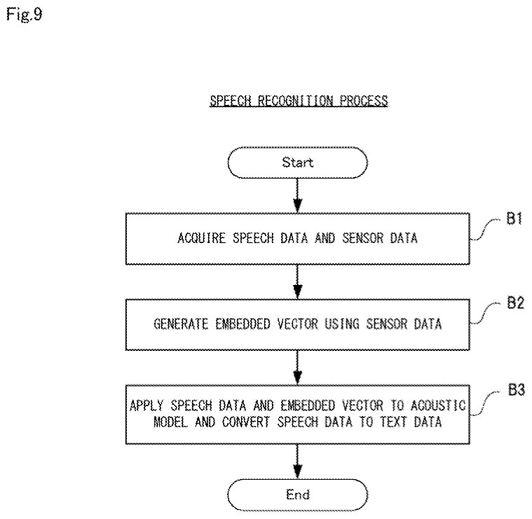

Next, the operation of the speech recognition apparatus 20 according to the second example embodiment will be described with reference to FIG. 9. FIG. 9 is a flow diagram illustrating an operation of the speech recognition apparatus according to the second example embodiment. In the following description, FIG. 8 will be referred to as appropriate. Further, in the second example embodiment, the speech recognition method is implemented by operating the speech recognition apparatus 20. Therefore, the following description of the operation of the speech recognition apparatus 20 applies to the speech recognition method to the second example embodiment.

As shown in FIG. 9, first, the data acquisition unit 21 acquires the speech data to be recognized and the sensor data (step B1). Further, as the data acquisition destination in step B1, an external terminal device or the like connected by a network, or the like can be mentioned.

Next, the speech recognition unit 22 generates the embedded vector using the sensor data acquired in step B1 (step B2). Specifically, for example, when the sensor data is image data, the speech recognition unit 22 generates the embedded vector by the method shown in FIG. 2 or FIG. 6. Further, when the sensor data is temperature data, the speech recognition unit 12 generates the embedded vector by the method shown in FIG. 3. When the sensor data is location data, the speech recognition unit 12 generates the embedded vector by the method shown in FIG. 4. When the sensor data is time data, the speech recognition unit 12 generates the embedded vector by the method shown in FIG. 5.

Next, the speech recognition unit 22 converts the speech data into text data by applying the speech data acquired in step B1 and the embedded vector generated in step B2 to the acoustic model (step B3). Further, the acoustic model used in step B3 is constructed by executing steps A1 to A3 shown in FIG. 7 in the first example embodiment.

Steps B1 to B3 are executed each time the speech data to be recognized and the sensor data are acquired. Further, the speech data is accurately recognized by steps B1 to B3.

As described above, according to the second example embodiment, it is possible to execute speech recognition by using the embedded vector generated without using speech recognition.

### Modified Example

As described in the modification 1 of the first example embodiment described above, also in the second example embodiment, the sensor data may be a combination of two or more among the image data, the temperature data, the location data, the time data, and the illuminance data. In the case that, the data acquisition unit 21 acquires all the combined sensor data. Further, in this case, the speech recognition unit 22 generates the embedded vector for each of the combined sensor data. Then, the speech recognition unit 22 applies the embedded vector for each generated sensor data to the acoustic mode to converts the speech data into text data.

[Program]

It is sufficient that the program according to the second example embodiment be a program that causes a computer to execute steps B1 to B3 illustrated in FIG. 9. The speech recognition apparatus 20 and the speech recognition method according to the second example embodiment can be realized by installing this program in the computer and executing this program. In this case, a processor of the computer functions and performs processing as the data acquisition unit 21 and the speech recognition unit 22. Further, example of the computer includes a general-purpose PC, and also a smartphone and tablet-type terminal device.

Also, the program according to the second example embodiment may be executed by a computer system constructed by a plurality of computers. In this case, for example, each computer may function as one of the data acquisition unit 21 and the speech recognition unit 22.

[Modified example]

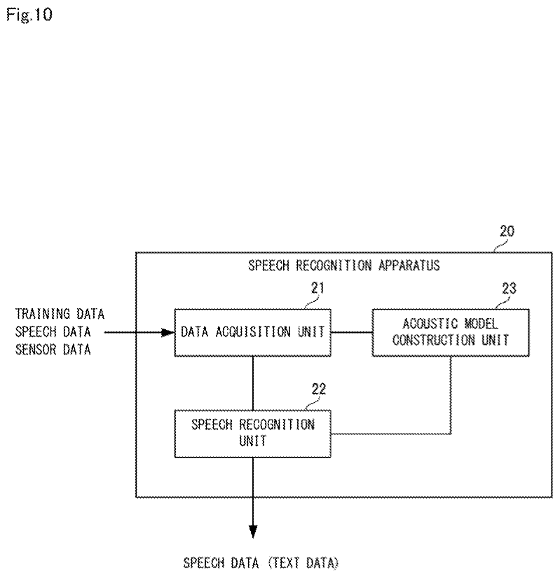

Subsequently, a modified example of the speech recognition apparatus according to the second example embodiment will be described with reference to FIG. 10. FIG. 10 is a block diagram illustrating a configuration of a speech recognition apparatus according to the modified example of the second example embodiment.

As shown in FIG. 10, in this modified example, the speech recognition apparatus 20 includes an acoustic model construction unit 23 in addition to the data acquisition unit 21 and the speech recognition unit 22 shown in FIG. 8. Further, the acoustic model construction unit 23 has the same function as the acoustic model construction unit 12 shown in FIG. 1 in the first example embodiment. Further, in this modified example, the data acquisition unit 21 acquires speech data to be training data, teacher data to be the training data, and sensor data related to the training data, similarly to the data acquisition unit 11 shown in FIG. 1 in the first example embodiment.

With such the configuration, in this modified example, the speech recognition apparatus 20 can have a function as the acoustic model learning apparatus. In this modified example, it is possible to construct the acoustic model and perform speech recognition with one apparatus.

(Physical Configuration)

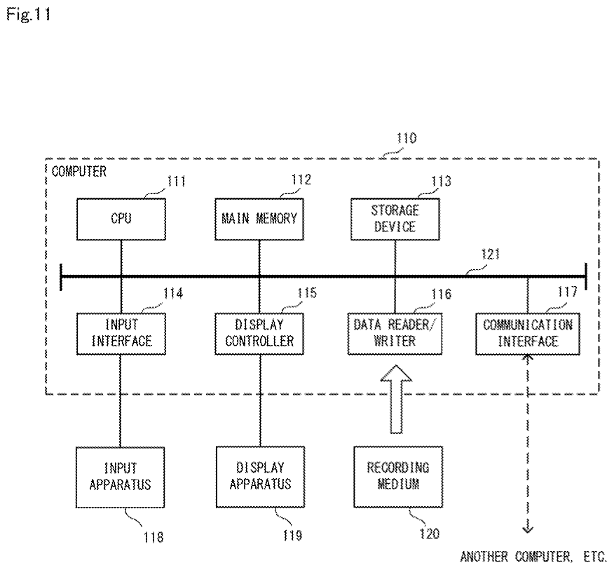

Here, a computer that realizes the acoustic model learning apparatus 10 by executing the program according to the first example embodiment, and a computer that realizes the speech recognition apparatus 20 by realizing the program according to the second example embodiment will be described with reference to FIG. 11. FIG. 11 is a block diagram illustrating an example of a computer that realizes the acoustic model learning apparatus or the speech recognition apparatus according to the example embodiments.

As illustrated in FIG. 11, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

Note that the computer 110 may include a GPU (Graphics Processing Unit) or an FPGA (Field-Programmable Gate Array) in addition to the CPU 111 or in place of the CPU 111.

The CPU 111 carries out various types of computation by deploying the program (codes) according to the example embodiment stored in the storage device 113 to the main memory 112, and executing the codes in a predetermined order. The main memory 112 is typically a volatile storage device, such as a DRAM (Dynamic Random-Access Memory). Also, the program according to the first and second example embodiments is provided in a state where it is stored in a computer readable recording medium 120. Note that the program according to the present example embodiment may also be distributed over the Internet connected via the communication interface 117.

Furthermore, specific examples of the storage device 113 include a hard disk drive, and also a semiconductor storage device, such as a flash memory. The input interface 114 mediates data transmission between the CPU 111 and an input device 118, such as a keyboard and a mouse. The display controller 115 is connected to a display device 119, and controls displays on the display device 119.

The data reader/writer 116 mediates data transmission between the CPU 111 and the recording medium 120, and executes readout of the program from the recording medium 120, as well as writing of the result of processing in the computer 110 to the recording medium 120. The communication interface 117 mediates data transmission between the CPU 111 and another computer.

Also, specific examples of the recording medium 120 include: a general-purpose semiconductor storage device, such as CF (Compact Flash®) and SD (Secure Digital); a magnetic recording medium, such as Flexible Disk; and an optical recording medium, such as CD-ROM (Compact Disk Read Only Memory).

Note that the acoustic model learning apparatus 10 and the speech recognition apparatus 20 according to the example embodiments can also be realized by using items of hardware corresponding to respective components, rather than by using the computer with the program installed therein. Furthermore, a part of the acoustic model learning apparatus 10 and the speech recognition apparatus 20 may be realized by the program, and the remaining part of these apparatus may be realized by hardware.

A part or all of the aforementioned example embodiment can be described as, but is not limited to, the following (Supplementary note 1) to (Supplementary note 24).

(Supplementary Note 1)

A speech recognition apparatus comprising:

a data acquisition unit that acquires speech data and sensor data to be recognized,

a speech recognition unit that converts the acquired speech data into text data by applying the acquired speech data and the acquired sensor data to an acoustic model which is constructed by machine learning using an embedded vector generated from sensor data related to training data in addition to speech data to be the training data and teacher data to be the training data.

(Supplementary Note 2)

The speech recognition apparatus according to Supplementary note 1, wherein the speech recognition unit generates the embedded vector from the acquired sensor data and converts the acquired speech data into text data by applying the acquired speech data and the generated embedded vector to the acoustic model.

(Supplementary Note 3)

The speech recognition apparatus according to Supplementary note 1 or 2, further comprising:

an acoustic model construction unit that constructs the acoustic model by machine learning using the embedded vector generated from the sensor data related to the training data in addition to the speech data to be the training data and the teacher data to be the training data.

(Supplementary Note 4)

The speech recognition apparatus according to Supplementary note 3, wherein the acoustic model construction unit inputs the sensor data related to the training data, to a model that outputs data related to the sensor data as the sensor data is input,

the acoustic model construction unit generates the embedded vector using the data output from the model and constructs the acoustic model using the generated embedded vector.

(Supplementary Note 5)

The speech recognition apparatus according to any one of Supplementary note s 1 to 4,

the sensor data is any one of image data, temperature data, location data, time data, and illuminance data, or a combination of two or more of them.

(Supplementary Note 6)

An acoustic model learning apparatus comprising:

a data acquisition unit acquires speech data to be training data, teacher data to be the training data, and sensor data related to the training data,

an acoustic model construction unit that constructs an acoustic model by machine learning using embedded vector generated from the sensor data related to the training data in addition to the speech data to be the training data and the teacher data to be the training data.

(Supplementary Note 7)

The acoustic model learning apparatus according to Supplementary note 6,

wherein the acoustic model construction unit inputs the sensor data related to the training data, to a model that outputs data related to the sensor data as the sensor data is input,

the acoustic model construction unit generates the embedded vector using the data output from the model and constructs the acoustic model using the generated embedded vector.

(Supplementary Note 8)

The acoustic model learning apparatus according to Supplementary note 6 or 7, the sensor data is any one of image data, temperature data, location data, time data, and illuminance data, or a combination of two or more of them.

(Supplementary Note 9)

A speech recognition method comprising:

a data acquisition step of acquiring speech data and sensor data to be recognized,

a speech recognition step of converting the acquired speech data into text data by applying the acquired speech data and the acquired sensor data to an acoustic model which is constructed by machine learning using an embedded vector generated from sensor data related to training data in addition to speech data to be the training data and teacher data to be the training data.

(Supplementary Note 10)

The speech recognition method according to Supplementary note 9,

wherein, in the speech recognition step, generating the embedded vector from the acquired sensor data and converting the acquired speech data into text data by applying the acquired speech data and the generated embedded vector to the acoustic model.

(Supplementary Note 11)

The speech recognition method according to Supplementary note 9 or 10, further comprising:

an acoustic model construction step of constructing the acoustic model by machine learning using the embedded vector generated from the sensor data related to the training data in addition to the speech data to be the training data and the teacher data to be the training data.

(Supplementary Note 12)

The speech recognition method according to Supplementary note 11,

wherein, in the acoustic model construction step,

inputting the sensor data related to the training data, to a model that outputs data related to the sensor data as the sensor data is input,

generating the embedded vector using the data output from the model, and

constructing the acoustic model using the generated embedded vector.

(Supplementary Note 13)

The speech recognition method according to any one of Supplementary note s 9 to 12,

the sensor data is any one of image data, temperature data, location data, time data, and illuminance data, or a combination of two or more of them.

(Supplementary Note 14)

An acoustic model construction method comprising:

a data acquisition step of acquiring speech data to be training data, teacher data to be the training data, and sensor data related to the training data,

an acoustic model construction step of constructing an acoustic model by machine learning using embedded vector generated from the sensor data related to the training data in addition to the speech data to be the training data and the teacher data to be the training data.

(Supplementary Note 15)

The acoustic model construction method according to Supplementary note 14,

Wherein, in the acoustic model construction step, inputting the sensor data related to the training data, to a model that outputs data related to the sensor data as the sensor data is input, and

generating the embedded vector using the data output from the model and constructing the acoustic model using the generated embedded vector.

(Supplementary Note 16)

The acoustic model construction method according to Supplementary note 14 or 15,

the sensor data is any one of image data, temperature data, location data, time data, and illuminance data, or a combination of two or more of them.

(Supplementary Note 17)

A computer-readable recording medium that includes a program, the program including instructions that cause a computer to carry out:

a data acquisition step of acquiring speech data and sensor data to be recognized,

a speech recognition step of converting the acquired speech data into text data by applying the acquired speech data and the acquired sensor data to an acoustic model which is constructed by machine learning using an embedded vector generated from sensor data related to training data in addition to speech data to be the training data and teacher data to be the training data.

(Supplementary Note 18)

The computer-readable recording medium according to Supplementary note 17,

wherein, in the speech recognition step, generating the embedded vector from the acquired sensor data and converting the acquired speech data into text data by applying the acquired speech data and the generated embedded vector to the acoustic model.

(Supplementary Note 19)

The computer-readable recording medium according to Supplementary note 17 or 18, the program further including instruction that cause the computer to carry out:

an acoustic model construction step of constructing the acoustic model by machine learning using the embedded vector generated from the sensor data related to the training data in addition to the speech data to be the training data and the teacher data to be the training data.

(Supplementary Note 20)

The computer-readable recording medium according to Supplementary note 19,

wherein, in the acoustic model construction step,

inputting the sensor data related to the training data, to a model that outputs data related to the sensor data as the sensor data is input,

generating the embedded vector using the data output from the model, and

constructing the acoustic model using the generated embedded vector.

(Supplementary Note 21)

The computer-readable recording medium according to any one of Supplementary note s 17 to 20,

the sensor data is any one of image data, temperature data, location data, time data, and illuminance data, or a combination of two or more of them.

(Supplementary Note 22)

A computer-readable recording medium that includes a program, the program including instructions that cause a computer to carry out:

a data acquisition step of acquiring speech data to be training data, teacher data to be the training data, and sensor data related to the training data,

an acoustic model construction step of constructing an acoustic model by machine learning using embedded vector generated from the sensor data related to the training data in addition to the speech data to be the training data and the teacher data to be the training data.

(Supplementary Note 23)

The computer-readable recording medium according to Supplementary note 22,

Wherein, in the acoustic model construction step, inputting the sensor data related to the training data, to a model that outputs data related to the sensor data as the sensor data is input, and

generating the embedded vector using the data output from the model and constructing the acoustic model using the generated embedded vector.

(Supplementary Note 24)

The computer-readable recording medium according to Supplementary note 22 or 23,

the sensor data is any one of image data, temperature data, location data, time data, and illuminance data, or a combination of two or more of them.

The invention has been described with reference to an example embodiment above, but the invention is not limited to the above-described example embodiment. Within the scope of the invention, various changes that could be understood by a person skilled in the art could be applied to the configurations and details of the invention.

### INDUSTRIAL APPLICABILITY

As described above, according to the present invention, it is possible to perform the speech recognition using the embedded vector generated without using speech recognition. The present invention is effective for various system in which speech recognition is performed.

### LIST OF REFERENCE SIGNS

10 Acoustic model learning apparatus
11 Data acquisition unit
12 Acoustic model construction unit
20 Speech recognition apparatus
21 Data acquisition unit
22 Speech recognition unit
23 Acoustic model construction unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A speech recognition apparatus comprising:
at least one memory storing instructions; and
at least one processor configured to execute the instructions to:
acquire speech data and sensor data to be recognized,
convert the acquired speech data into text data by applying the acquired speech data and the acquired sensor data to an acoustic model which is constructed by machine learning using an embedded vector generated from sensor data related to training data in addition to speech data to be the training data and teacher data to be the training data.

2. The speech recognition apparatus according to claim 1,
wherein, further at least one processor configured to execute the instructions to: generate the embedded vector from the acquired sensor data and converts the acquired speech data into text data by applying the acquired speech data and the generated embedded vector to the acoustic model.

3. The speech recognition apparatus according to claim 1, further at least one processor configured to execute the instructions to:
construct the acoustic model by machine learning using the embedded vector generated from the sensor data related to the training data in addition to the speech data to be the training data and the teacher data to be the training data.

4. The speech recognition apparatus according to claim 3,
wherein, further at least one processor configured to execute the instructions to: input the sensor data related to the training data, to a model that outputs data related to the sensor data as the sensor data is input,
generate the embedded vector using the data output from the model and constructs the acoustic model using the generated embedded vector.

5. The speech recognition apparatus according to claim 1,
the sensor data is any one of image data, temperature data, location data, time data, and illuminance data, or a combination of two or more of them.

6.-8. (canceled)

9. A speech recognition method comprising:
acquiring speech data and sensor data to be recognized,
converting the acquired speech data into text data by applying the acquired speech data and the acquired sensor data to an acoustic model which is constructed by machine learning using an embedded vector generated from sensor data related to training data in addition to speech data to be the training data and teacher data to be the training data.

10. The speech recognition method according to claim 9,
wherein generating the embedded vector from the acquired sensor data and converting the acquired speech data into text data by applying the acquired speech data and the generated embedded vector to the acoustic model.

11. The speech recognition method according to claim 9, further comprising:
constructing the acoustic model by machine learning using the embedded vector generated from the sensor data related to the training data in addition to the speech data to be the training data and the teacher data to be the training data.

12. The speech recognition method according to claim 11,
wherein inputting the sensor data related to the training data, to a model that outputs data related to the sensor data as the sensor data is input,
generating the embedded vector using the data output from the model, and
constructing the acoustic model using the generated embedded vector.

13. The speech recognition method according to claim 9,
the sensor data is any one of image data, temperature data, location data, time data, and illuminance data, or a combination of two or more of them.

14. A non-transitory computer-readable recording medium that includes a program, the program including instructions that cause a computer to carry out:
acquiring speech data and sensor data to be recognized,
converting the acquired speech data into text data by applying the acquired speech data and the acquired sensor data to an acoustic model which is constructed by machine learning using an embedded vector generated from sensor data related to training data in addition to speech data to be the training data and teacher data to be the training data.

15. The non-transitory computer-readable recording medium according to claim 14,
wherein generating the embedded vector from the acquired sensor data and converting the acquired speech data into text data by applying the acquired speech data and the generated embedded vector to the acoustic model.

16. The non-transitory computer-readable recording medium according to claim 14, the program further including instruction that cause the computer to carry out:
constructing the acoustic model by machine learning using the embedded vector generated from the sensor data related to the training data in addition to the speech data to be the training data and the teacher data to be the training data.

17. The non-transitory computer-readable recording medium according to claim 11,
wherein inputting the sensor data related to the training data, to a model that outputs data related to the sensor data as the sensor data is input,
generating the embedded vector using the data output from the model, and
constructing the acoustic model using the generated embedded vector.

18. The non-transitory computer-readable recording medium according to claim 14,
the sensor data is any one of image data, temperature data, location data, time data, and illuminance data, or a combination of two or more of them.
